(19) United States
(12) Patent Application Publication
(10) Pub. No.: US 2025/0125332 A1
(43) Pub. Date: Apr. 17, 2025

(54) METHOD FOR STABILIZING COPPER-RICH SILICIDE PHASES, AND USE OF SAID COPPER-RICH SILICIDE PHASES IN A LITHIUM-ION BATTERY

(71) Applicant: NORCSI GMBH, Halle (DE)

(72) Inventors: Udo REICHMANN, Wilsdruff (DE); Marcel NEUBERT, Kreischa (DE); Andreas KRAUSE-BADER, Dresden (DE)

(73) Assignee: NORCSI GMBH, Halle (DE)

(21) Appl. No.: 18/682,039

(22) PCT Filed: Aug. 9, 2022
(86) PCT No.: PCT/EP2022/072350

§ 371 Date: Feb. 7, 2024

(30) Foreign Application Priority Data
Aug. 9, 2021 (DE) 10 2021 120 615.4
Aug. 9, 2021 (DE) 10 2021 120 635.9
Aug. 9, 2021 (DE) 102021 120 624.3
Oct. 13, 2021 (DE) 10 2021 126 493.6

(51) Int. Cl. H01M 4/04; H01M 4/02; H01M 4/36; H01M 4/38; H01M 4/62; H01M 4/66; H01M 10/0525

(52) U.S. Cl. CPC H01M 4/0471; H01M 4/0421; H01M 4/364; H01M 4/386; H01M 4/626; H01M 4/661; H01M 10/0525; H01M 2004/027

(57) ABSTRACT

The invention relates to a method for stabilizing copper-rich silicide phases, in which method a silicon layer structure is applied to a carrier substrate. The problem addressed by the present invention of, in particular, specifying a method by means of which the properties of phase separation and microstructure formation can be varied in a controlled way, while at the same time the process should be able to be carried out as simply, quickly and efficiently as possible, is solved by means of a method for stabilizing copper-rich silicide phases, in which method a silicon layer structure is applied to a carrier substrate, a layer of the silicon layer structure being applied from a mixture of at least one metal and silicon, which mixture is subsequently subjected to short-term tempering, wherein, by the setting of process parameters, such as a pulse duration in the range of 0.01 to 100 ms and/or a pulse energy amount in the range of 0.1 to 100 J/cm² in the short-term tempering and preheating or cooling of the carrier substrate to a range of 4° C. to 200° C. and a material selection of the applied mixture of the layer of the silicon layer structure, phase separation of the applied layer is controlled.

The invention relates to a method for stabilizing copper-rich silicide phases, in which a silicon layer structure is applied to a carrier substrate.

The invention relates additionally to the use of the method of the invention for producing a high-capacitance electrode material in a lithium-ion battery, more particularly for a silicon anode, and to an anode material and the use thereof in a battery cell and a lithium-ion battery, and to an anode produced with the method of the invention.

If non-specific mixed copper (Cu)-silicon (Si) laminas are exposed to high temperatures, the respective concentrations of copper and silicon dictate the formation of single or multiple phases of copper silicides or mixed crystals, referred to as solid solutions.

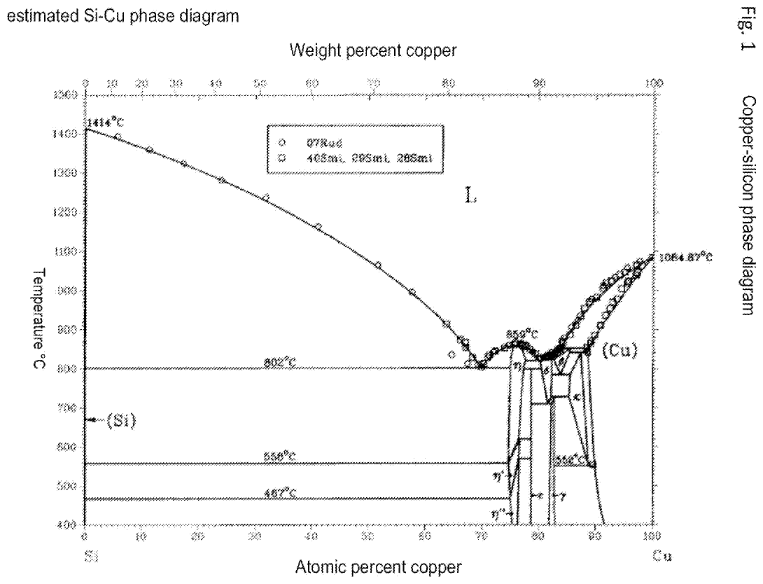

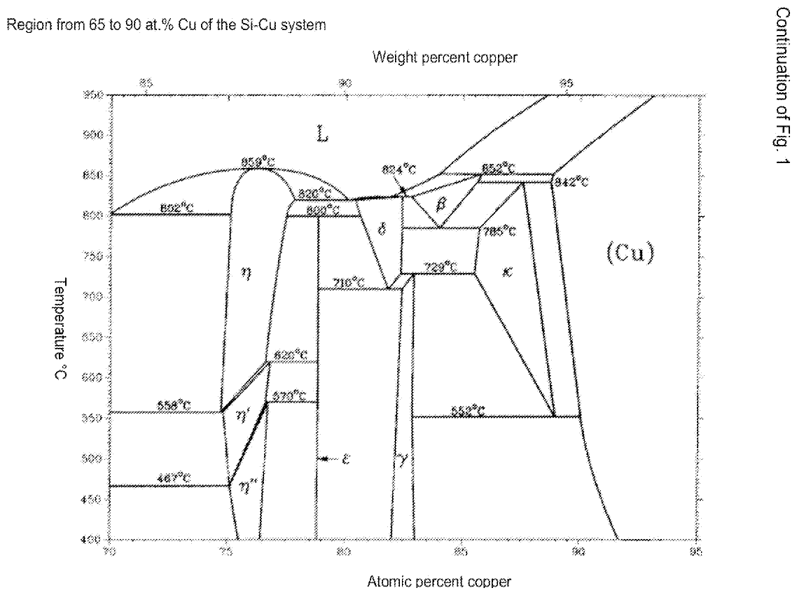

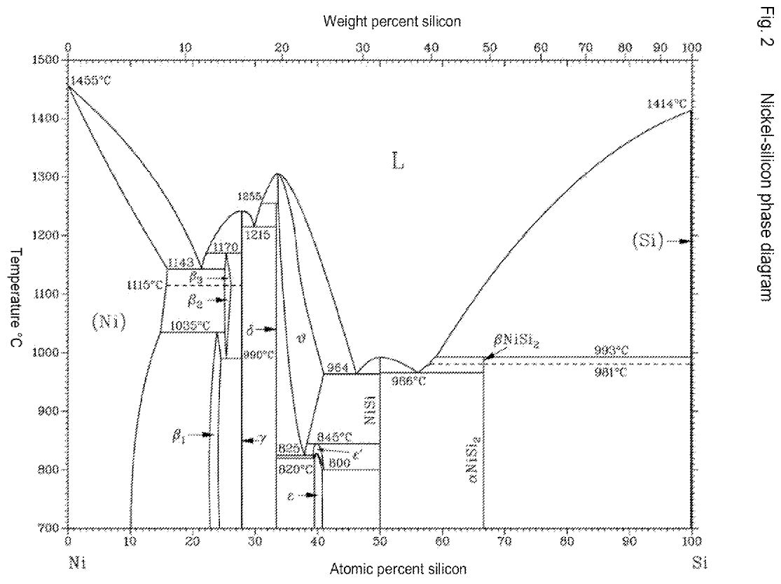

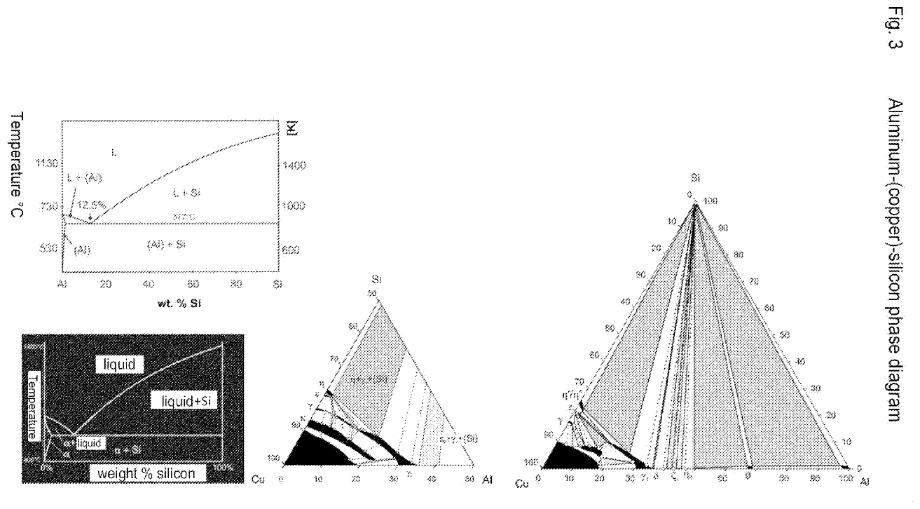

The three silicides that exist at low temperature in the equilibrium state in a mixed copper-silicon lamina are Cu₃Si, Cu₁₅Si₄ and Cu₃Si. The stable intermetallic phase with the greatest concentration of silicon is Cu₃Si (Chromik, R. R., Neils, W. K. & Cotts, E. J. Thermodynamic and kinetic study of solid state reactions in the Cu—Si system. Journal of Applied Physics 86, 4273 (1999)). Higher proportions of silicon (hypereutectic phase, Cu3-αSi (α>0)) result correspondingly in mixtures of (Si) and the Cu₃Si phase. With Si—Cu mixtures having hypoeutectic concentrations, i.e., more copper, or copper-rich mixtures, the Cu₃Si phase is the first to form on heating beyond 170° C. (Russell, S. W., Li, J. & Mayer, J. W. In situ observation of fractal growth during a-Si crystallization in a Cu3Si matrix. Journal of Applied Physics 70, 5153-5155 (1991)); at higher temperatures, this phase transitions to the copper phases Cu₁₅Si₄ and Cu₅Si. A microstructure is developed in which the phases are formed according to their proportions. The morphology and distribution of this microstructure is determined via the cooling rate in an annealing treatment applied to the lamina. Slow cooling rates and/or small temperature gradients promote developed phase separation with large microstructures, whereas fast cooling rates and/or high temperature gradients produce phase separation with small-particle microstructures. The phase separation is dependent on the constituent elements of the lamina and on the intermetallic phases formed. As well as the existence of binary systems such as Cu—Si with three intermetallic phases and Ni—Si with five intermetallic phases, there are also systems such as Al—Si, in which, while there is a eutectic, no intermetallic phases are formed; see phase diagrams for Cu—Si (FIG. 1), Ni—Si (FIG. 2), Al—Si (FIG. 3), Ti—Si (FIG. 4).

Using a combination of multiple different metals with silicon, the properties of phase separation and microstructure formation can be additionally customized.

It is therefore the object of the present invention in particular to specify a method with which the properties of phase separation and corresponding microstructure formation may be customized, the intention being that the process should be able to be carried out with maximum simplicity, rapidity and efficiency.

The object is achieved by a method according to independent claim 1. In the method for stabilizing copper-rich silicide phases in a microstructure, in which a silicon layer structure is applied to a carrier substrate, a layer of the silicon layer structure composed of a mixture of at least one metal and silicon is applied and is subsequently subjected to accelerated annealing, where through establishment of operating parameters, such as a pulse duration in the range from 0.01 to 100 ms and/or a pulse energy in the range from 0.1 to 100 J/cm² in the accelerated annealing, and preheating or cooling of the carrier substrate in the range from 4° C. to 200° C., and selection of the materials in the applied mixture of the layer of the silicon layer structure, phase separation in the applied layer is controlled and the microstructure develops.

Accelerated annealing refers in particular to flash-lamp annealing and/or laser annealing. Flash-lamp annealing takes place with a pulse duration or annealing time in the range from 0.3 to 20 ms and a pulse energy in the range from 0.3 to 100 J/cm². In the case of laser annealing, the annealing time of 0.01 to 100 ms is established through the rate of scanning of the local heating site, to generate an energy density of 0.1 to 100 J/cm². The heating ramps achieved in the accelerated annealing are situated in the range, necessary for the method, of 10\hat{ }⁴-10\hat{ }⁷ K/s. Flash-lamp annealing for this purpose utilizes a spectrum in the visible wavelength range, whereas for laser annealing, discrete wavelengths in the range of the infrared (IR) to ultraviolet (UV) spectrum are used.

A silicon layer structure refers to the various laminas of a laminar construction or laminar stack of an Si electrode. A laminar stack comprises at least one layer or lamina, with a layer or lamina being formed of at least one material or of a mixture of more than one material. Layer and lamina are terms used synonymously.

With the method of the invention, any desired layer structures or laminar stacks can be built up onto numerous substrates without vacuum interruption, as is usual for sputtering operations. As a result of the accelerated annealing, the annealing steps can be carried out rapidly and efficiently. Accelerated annealing offers great variation in operational settings, such as the flash-lamp energy or laser energy, the pulse duration, and the preheating or cooling of the substrate.

These fundamental operating steps give rise to a massive spectrum of parameters which can be custom-tailored to a desired application. In particular, the accelerated annealing constitutes a decisive advantage because of the targeted input of energy. The accelerated annealing can be used to stabilize high-temperature phases which do not withstand the equilibrium state.

In one embodiment of the method of the invention, the phase separation results in formation of a conductive matrix of metal or silicides, in which nanoscale silicon is embedded.

Nanoscale silicon refers to silicon in amorphous or nanocrystalline order which is present spatially in at least one dimension of less than 100 nm extent. For crystalline Si, 100 nm is considered a limiting value for volume expansion on lithium intercalation; at or below this figure, stresses are dissipated with no destruction of the morphology, i.e., no cracks, fractures, or the like.

In another embodiment of the method of the invention, the carrier substrate is formed primarily of copper.

The use of a copper substrate and the influencing of the phase separation through the chosen operating parameters result in formation of a copper silicide matrix which includes amorphous or nanocrystalline regions of pure silicon. Hence a heterogeneous structure arises in which there are electrically conductive regions whose capacity for lithium intercalation is little or none, and also regions containing virtually pure Si (ideally amorphous), which has a high storage capacity.

Copper-rich silicide phases are naturally more conductive than less copper-rich silicide phases. Where Si—Cu regions of high and low Si concentration are formed in a non-specific mixture, this is favorable, accordingly, for use in a battery and for the performance thereof. If the accelerated annealing results in formation not of Cu₃Si but rather of copper silicides with a higher concentration, there are accordingly more regions of pure silicon left. Hence the silicide matrix achieves a high conductivity and the level of utilization of the remaining (amorphous or nanocrystalline) silicon present is high. It has emerged that at the extreme, there is even formation of a pure copper matrix in the silicon layer as a result of phase separation, representing the ideal case of a corresponding nanostructure.

In one embodiment of the method of the invention, the phase separation leads to formation of a copper silicide matrix in the layers of the silicon layer structure.

By varying the pulse length it is possible to exert targeted influence over the nanostructuring. Matrixes with dendritic conductivity are developed, which also permit good electrical conductivity for a relatively thick layer of low-conductivity silicon. Dendrites are treelike or bushlike crystal structures. They come about to an increased extent through the admixing of aluminum in silicon-metal laminas.

In another embodiment of the method of the invention, the copper silicide matrix is formed/generated not only by the stable intermetallic phases (copper silicide phases) Cu₃Si, Cu₁₅Si₄ and Cu₅Si which exist in a thermodynamic equilibrium state at room temperature but also, as a result of the accelerated annealing, by high-temperature-stabilized, copper-rich intermetallic phases, such as Cu₇Si and Cu₉Si, with these copper-rich intermetallic phases also forming in silicon-rich Si—Cu mixtures. The mixtures develop in spite of high proportions of silicon relative to copper, i.e., in hypoeutectic concentrations.

In a further embodiment of the method of the invention, the layer of the silicon layer structure is admixed with one or more of the elements nickel (Ni), aluminum (Al), tin (Sn) or titanium (Ti).

In the binary nickel-silicon system there are five intermetallic phases, whereas in systems such as Al—Si there is only a eutectic and no intermetallic phases are formed. Aluminum acts to promote, for example, the formation of dendrites in Cu—Si systems and increases the conductivity of the silicon. In contrast to copper, there are lithium-active phases for Sn and Ti. In the silicon, these phases are able to moderate volume expansion without generating hard interfaces during volume expansion.

In another further embodiment of the method of the invention, nanostructuring of the silicide matrix is established through the accelerated annealing.

Varying, for example, the pulse length of the flash in flash-lamp annealing or in laser annealing allows the nanostructuring to be tailored.

In one embodiment of the method of the invention, a morphology and a distribution of the developing phases within the copper silicide matrix are established by means of a cooling rate.

Advantageously, by means of a slow cooling rate, it is possible to establish phase separation with large microstructures, while phase separation with small-particle microstructures can be established by means of a rapid cooling rate.

In another embodiment of the method of the invention, the proportion, in the copper silicide matrix formed, of copper-rich silicides such as Cu₅Si, Cu₇Si, Cu₉Si or CuₓSi_{y} with x, y as natural numbers amounts to more than 50% of the total silicide proportions. Advantageously, the amount of the silicides in the lamina should be established such that the total capacity of the copper silicide matrix/silicon layer is not below 2000 mAh/cm², so as to ensure sufficient battery capacity.

Characteristically, the expansions of the phases formed, such as Cu₃Si, Cu₁₅Si₄ and Cu₅Si, which have developed as copper silicide matrix in the multilayer structure produced in accordance with the invention in the silicon lamina, amount visibly to 200 nm in a silicon lamina of 1 μm thickness. Through finer subdivision of the individual layers, this may be adapted as required for sufficient stabilization in battery operation. The objective is a copper silicide matrix which stabilizes the silicon. The proportion of copper silicide (CuSi) must be of a magnitude such that the stability limit of pure silicon is not exceeded.

Any change in the parameters of the accelerated annealing, such as pulse duration, pulse energy and/or preheating/cooling, leads to a large number of results. For stable battery operation with high-volume expansion, amorphous silicon regions in the order of magnitude of 100 nm are typically ideal. Dendritic conductive matrixes also allow good electrical contacting of a relatively thick layer of low-conductivity silicon. These dendrites are formed to an increased extent by the admixing of aluminum to Si metal layers.

The layers of the silicon layer structure are applied advantageously by dry deposition methods such as physical (PVD), exemplified by sputtering, and/or chemical vapor deposition (CVD).

The phase separation described takes place with formation of diverse intermetallic phases, sometimes simultaneously, sometimes successively. These intermetallic phases have different densities and/or lattice parameters. It is therefore possible for interfaces to be formed, before an end state or end phase is reached, which possess a relatively low density or occupy a greater spatial volume. As a result, at the end of operation, a foam structure is obtained, with void structures distributed in the heterogeneous silicide matrix, in which amorphous silicon is embedded. These void structures are additionally able to compensate the volume expansion of the silicon on lithium intercalation. In the method of the invention it has been demonstrated that the laminar thickness of a system of materials has increased fivefold, although a doubling or tripling is realistic with typical lattice expansions and oxide formation. The rest of the thicknesses or increase in volume is therefore ascribed to the void structures formed.

It is therefore advantageous to use the method of the invention for stabilizing copper-rich silicide phases in accordance with the method claims for producing a high-capacitance electrode material in a lithium-ion battery, more particularly for a silicon anode.

Additionally it is advantageous to produce the anode material for an electrochemical cell, more particularly a lithium-ion battery.

This anode material may be employed in a battery cell, which may in turn be installed in a battery with at least one battery cell.

The advantage of the method of the invention is that the properties described are not furnished and achieved through complicated operations; instead, they come about naturally from the targeted use of the accelerated annealing. This is accomplished in one operating step and is highly scalable and therefore extremely cost-efficient. Other methods are much more complicated, require much more energy than the accelerated annealing, and cannot be applied in a scalable manner.

The object on which the invention is based is also achieved by an anode according to claim 16. The anode of the invention is suitable for use in a lithium-ion battery and comprises a current collector, preferably of copper, and a multilayer structure deposited on the current collector and produced by the method of claims 1 to 11. The multilayer structure is formed of at least two layers, with one layer being formed of a mixture of at least one metal and silicon, which form a copper silicide matrix, the copper silicide matrix including (intermetallic) phases depending on the metal used.

In one embodiment of the anode of the invention, the copper silicide matrix exhibits a lateral expansion of 50% to 90%, normalized to the final lamina thickness of the multilayer structure.

In another embodiment of the anode of the invention, a microstructure is developed in the multilayer structure and contains different intermetallic metal-rich phases—as well as Cu₃Si, Cu₁₅Si₄ and Cu₅Si, a high proportion of copper-rich silicides such as Cu₅Si, Cu₇Si and Cu₉Si, where the expansion of the phases formed amounts to at least 50%, normalized to the final lamina thickness in the microstructure, with pure silicon having a maximum thickness per layer of 1 μm. For example, for a Cu—Si layer 1.5 μm thick, the expansion of the copper silicide matrix ought to amount to at least 0.5 μm. For crystalline silicon, a maximum expansion of 300 nm, and for amorphous silicon a maximum expansion of 1 μm, are deemed to be an upper limit for a stable, uniform volume expansion on lithium intercalation, without the silicon structure being pulverized. This is referred to as the stability criterion for pure silicon.

In a further embodiment of the anode of the invention, the total proportion in percent by volume of the nanoscale silicon intercalated within the copper silicide matrix, calculated for a total Si content of the multilayer structure, is from 40% to 95%, so that/in which case the stability criterion is not reached.

The invention will be elucidated in more detail below, using exemplary embodiments.

The drawings show the following:

FIG. 1 copper—silicon phase diagram;

FIG. 2 nickel—silicon phase diagram;

FIG. 3 aluminum—(copper)—silicon phase diagram;

FIG. 4 titanium—(aluminum)—silicon phase diagram;

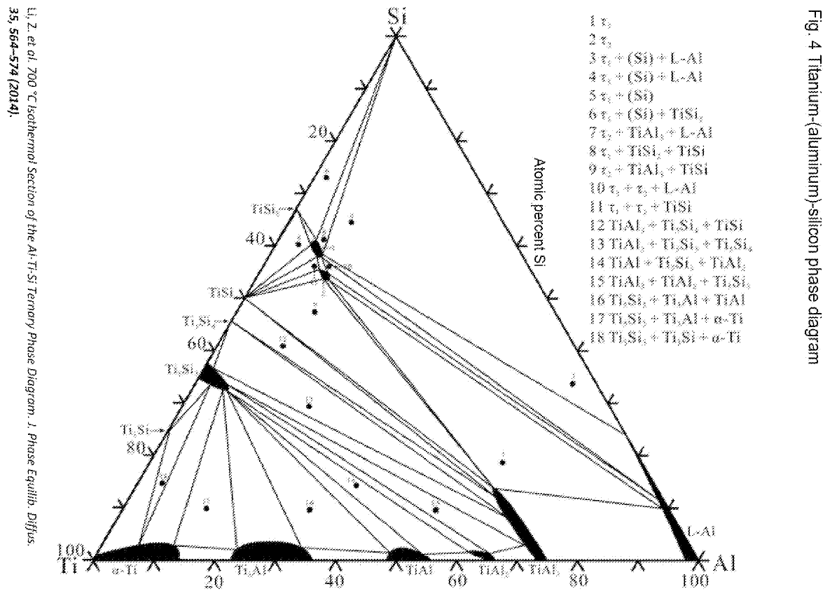

FIG. 5 Cu—Si—Ti phase diagram;

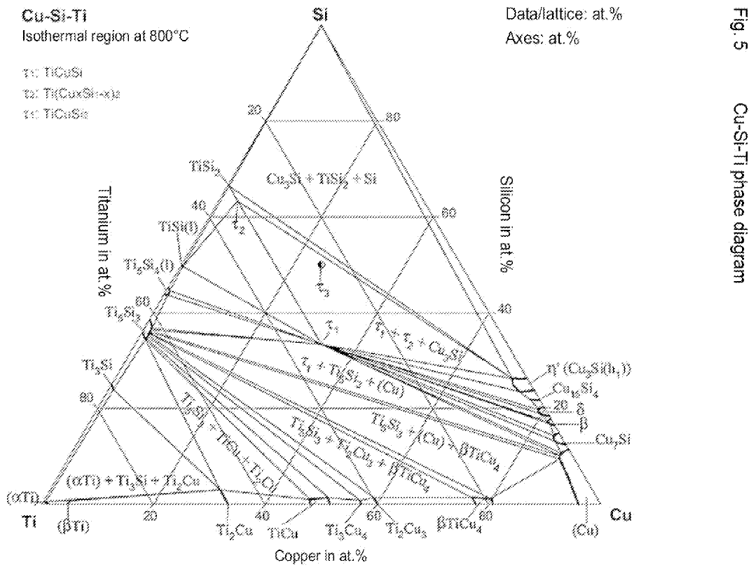

FIG. 6 schematic representation of the layer structure and the development of phase separation after flash-lamp annealing;

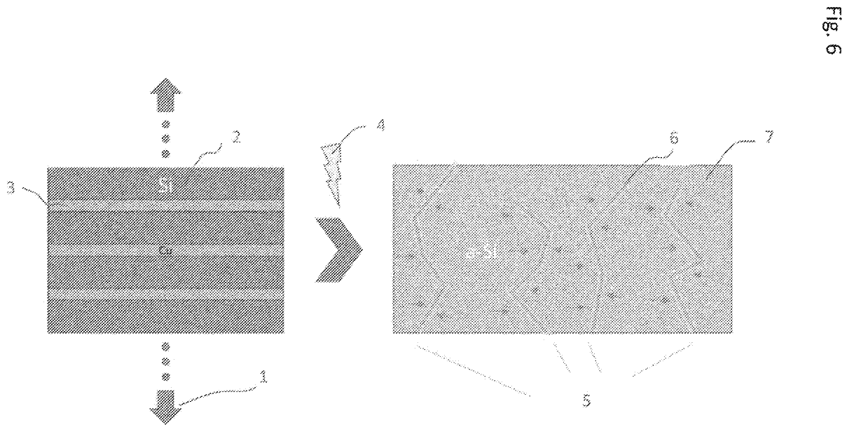

FIG. 7 SEM micrograph of a total layer of Si/Cu/Si with developed copper silicide matrix (dendrite structure) produced with the method of the invention;

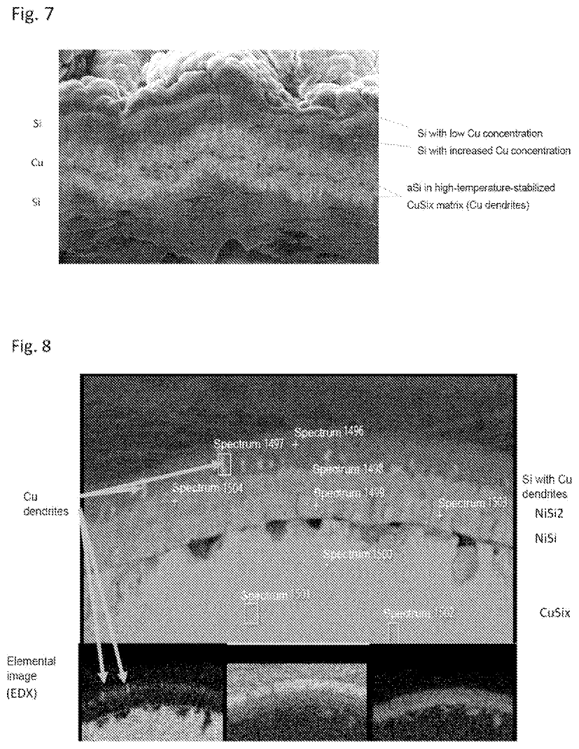

FIG. 8 SEM image and elemental analysis of a Cu—Si—Ni system, produced with the method of the invention;

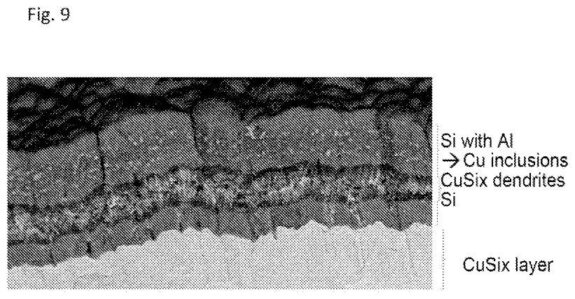

FIG. 9 SEM micrograph of a Cu—Si—Al system.

FIG. 6 shows a schematic representation of a silicon layer structure 1 produced, with silicon laminas 2 alternating with copper laminas 3 and/or with laminas of materials other than copper. As a result of the accelerated annealing, more particularly flash-lamp annealing or laser annealing 4, heterogeneous mixed layers are formed through a phase separation 5. In the example depicted, the system produced contains large regions of amorphous silicon 7, which has a high storage capacity for the intercalation of lithium. Furthermore, the accelerated annealing leads to development of regions in which the copper intergrows with the silicon and develops the desired dendrites, which may develop a copper silicide (CuSiₓ) matrix 6 up to a pure copper matrix and which therefore exhibit high electrical conductivity. FIG. 6 shows the mixture of Cu/Si from a layer structure. Also possible in principle would be a homogeneous SiCu layer, produced by co-sputtering or sputtering directly from an SiCu target. Accelerated annealing then leads to phase separation. It is therefore also possible to sputter a mixed layer, rather than sputtering Si/Cu layers individually. The advantage is that the layers do not have to be applied in alternation, but instead in one operating step.

FIG. 7 shows an SEM micrograph of a heterogeneous mixed layer by phase separation, which is brought about and produced with the method of the invention. The total layer of Si/Cu/Si exhibits two layers of Si, each 1 μm thick, with between them Cu with a thickness of 300 nm. After the accelerated annealing, the Cu has intergrown with the Si, and the desired dendrites are developed. Dendrites of Cu or CuSiₓ have formed in about 50% of each Si layer. The lighter regions are copper-rich silicides or copper, distributed heterogeneously in the silicon (darker portions).

Using a Cu—Si system produced with the method of the invention, it was demonstrated that copper-rich phases can be formed even in hypereutectic systems Cu_{(3-α)}Si (α>0). Accordingly, by x-ray diffractometry, not only the low-temperature-stable Cu₅Si but likewise Cu₇Si and even Cu₉Si phases were measured. Admixing nickel to the system additionally promotes the formation of these copper-rich silicide phases. The formation of the copper-rich silicide phases is induced by the limited kinetics and diffusion during the process of accelerated annealing, in which even in hypereutectic systems there are local instances of hypoeutectic concentrations and hence formation of copper-rich phases. The addition of materials such as aluminum, which do not develop intermetallic phases with silicon, additionally supports this process.

FIG. 8 shows a Cu—Si—Ni system (SEM image and elemental analysis) in which, from an NiSiₓ layer, copper and/or copper-rich silicides are developed as a dendrite in the silicon (the starting layer is an Si/Ni/CuSiₓ structure).

FIG. 9 shows a complex layer structure on a CuSiₓ layer both with dendrite structures and with copper inclusions as particlelike structures which condense in the silicon by the admixing of aluminum.

In summary, the method of the invention enables the formation of a conductive matrix of metal and silicides in which nanoscale Si is embedded. In particular, the method of the invention enables the formation of a copper-rich silicide matrix up to a pure copper matrix, which produces a substantial improvement in the heterogeneity of the mixed layer and consequently in battery performance. Through the targeted variation of the operating parameters, such as pulse duration, pulse energy in the accelerated annealing, and preheating or cooling, it is possible to establish the structure of the surrounding conductive matrix. The possibilities include particlelike embedments, pyramidal, corallike or dendritic structures and even columnar pillar structures, in order to select the best structure for the application. The method of the invention enables the production of foam structures in the laminar layer, which results in improved stress compensation on intercalation of lithium into silicon and hence improves battery performance.

### List of Reference Signs

1 silicon layer structure
2 silicon lamina/layer
3 copper lamina/layer
   2+3 mixed Si/Cu layer with adjustable concentration
4 accelerated annealing, more particularly flash-lamp annealing step or laser annealing step
5 phase separation; dendrites of copper or copper silicide
6 copper silicide matrix/Cu matrix;
7 amorphous or nanocrystalline nanoscale silicon
   5+6+7 nanoscale silicon embedded in conductive silicide matrix

1. A method for stabilizing copper-rich silicide phases in a microstructure, in which a silicon layer structure is applied to a carrier substrate, characterized in that a layer of the silicon layer structure composed of a mixture of at least one metal and silicon is applied and is subsequently subjected to accelerated annealing, where through establishment of operating parameters, such as a pulse duration in the range from 0.01 to 100 ms and/or a pulse energy in the range from 0.1 to 100 J/cm² in the accelerated annealing, and preheating or cooling of the carrier substrate in the range from 4° C. to 200° C., and selection of the materials in the applied mixture of the layer of the silicon layer structure, phase separation in the applied layer is controlled and the microstructure develops.

2. The method as claimed in claim 1, characterized in that through the phase separation, a conductive matrix of metal or silicides is formed in which nanoscale silicon is embedded.

3. The method as claimed in claim 1, characterized in that the carrier substrate is formed primarily of copper.

4. The method as claimed in claim 1, characterized in that through the phase separation, a copper silicide matrix is formed in the layers of the silicon layer structure.

5. The method as claimed in claim 4, characterized in that the copper silicide matrix is formed not only from the intermetallic phases Cu3Si, Cu15Si4 and Cu5Si which exist in the thermal equilibrium but also from high-temperature-stabilized, copper-rich intermetallic phases, such as Cu7Si and Cu9Si, with these copper-rich intermetallic phases also developing in silicon-rich Si—Cu mixtures.

6. The method as claimed in claim 1, characterized in that the layer of the silicon layer structure is admixed with one or more of the elements nickel (Ni), aluminum (Al), tin (Sn) or titanium (Ti).

7. The method as claimed in claim 1, characterized in that nanostructuring of the silicide matrix is established through the accelerated annealing.

8. The method as claimed in any of claims 1, characterized in that a morphology and a distribution of the developing phases within the copper silicide matrix are established by means of a cooling rate.

9. The method as claimed in claim 8, characterized in that phase separation with large microstructures is established by means of a slow cooling rate, and phase separation with small-particle microstructures is established by means of a rapid cooling rate.

10. The method as claimed in claim 1, characterized in that the proportion, in the copper silicide matrix formed, of copper-rich silicides such as Cu5Si, Cu7Si, Cu9Si or CuxSiy with x,y as natural numbers amounts to more than 50% of the total silicide proportions.

11. The method as claimed in claim 1, characterized in that the layers of the silicon layer structure are applied by dry deposition operations, such as physical, PVD, and/or chemical vapor deposition, CVD.

12. The use of the method for stabilizing copper-rich silicide phases of claim 1 for producing a high-capacitance electrode material in a lithium-ion battery, more particularly for a silicon anode.

13. An anode material for an electrochemical cell, more particularly a lithium-ion battery, produced by the method as claimed in claim 1.

14. A battery cell, more particularly lithium-ion cell, comprising an anode material as claimed in claim 13.

15. A battery, more particularly lithium-ion battery, comprising at least one battery cell as claimed in claim 14.

16. An anode suitable for use in a lithium-ion battery, comprising a current collector, preferably of copper, and a multilayer structure deposited on the current collector and producible by the method of claim 1, characterized in that the multilayer structure is formed of at least two layers, with one layer being formed of a mixture of at least one metal and silicon which form a copper silicide matrix, the copper silicide matrix including intermetallic phases depending on the metal used.

17. The anode as claimed in claim 16, characterized in that the copper silicide matrix exhibits a lateral expansion of 50% to 90%, normalized to the final lamina thickness of the multilayer structure.

18. The anode as claimed in claim 16, characterized in that a microstructure is developed in the multilayer structure and contains different intermetallic metal-rich phases, such as Cu5Si, Cu7Si and Cu9Si, where the expansion of the phases formed amounts to at least 50%, normalized to the final lamina thickness of the multilayer structure in the microstructure, with pure silicon having a maximum thickness per layer of 1 μm.

19. The anode as claimed in claim 1, characterized in that the total proportion in percent by volume of the nanoscale silicon intercalated within the copper silicide matrix, calculated for a total Si content of the multilayer structure, is from 40% to 95%.
